(19) United States
(12) Patent Application Publication
(10) Pub. No.: US 2015/0060371 A1
(43) Pub. Date: Mar. 5, 2015

(54) Reactor for Substrate Oxidation

(71) Applicant: The University of Birmingham, Birmingham (GB)

(72) Inventor: Bushra Al-Duri, Edgbaston (GB)

(73) Assignee: The University of Birmingham, Birmingham (GB)

(21) Appl. No.: 14/380,256

(22) PCT Filed: Feb. 19, 2013
(86) PCT No.: PCT/GB2013/050392

§ 371 Date: Aug. 21, 2014

(30) Foreign Application Priority Data
Feb. 23, 2012 (GB) 1203147.2

(51) Int. Cl. C02F 1/72

(52) U.S. Cl. CPC C02F 1/72
USPC 210/758; 210/205

(57) ABSTRACT

A reactor and process for the oxidation of substrates, comprising: a first reaction chamber configured to dissolve substrates in a fluid, the first reaction chamber comprising a linking outlet; the linking outlet being connected to a tubular reaction chamber downstream of the first reaction chamber, conditions in the first reaction chamber being subcritical for the fluid, and conditions in the tubular reaction chamber being supercritical for the fluid carrying the dissolved substrates

### FIELD

The invention relates to a reactor and process for oxidation of substrates. In particular, the invention relates to a reactor and process comprising multiple reaction chambers.

### BACKGROUND

Above their critical temperature and pressure fluids undergo structural changes. These changes result in thermodynamic properties and reaction behaviours which are very different from those observed in subcritical systems. For instance, at temperatures above 374° C. and pressures above 220.4 bars (22 mPa), water becomes supercritical and hydrogen bonds are weakened, changing the physical properties of the water so that it becomes a solvent for all organics and gases (unlike ambient water). As such, in the supercritical range, water becomes an ideal reaction medium for a large range of chemical reactions that are not possible in this medium (if at all) at sub-critical conditions. This dramatically widens the scope of potential uses for water and other liquids.

One use for supercritical liquids is the treatment of aqueous waste streams containing chemically stable hazardous pollutants, by oxidation in a supercritical water medium. The process is known as supercritical water oxidation (SCWO).

In a SCWO process aqueous waste is contacted with oxidant (air or oxygen gas) in a reactor under supercritical water conditions (above 375° C. and 220.4 bars (22 mPa) respectively). Rapid oxidation occurs, taking only seconds or minutes. This results in a process which has excellent efficiency. By virtue of SCW solvating power the reaction medium is single phase, facilitating complete reaction. For most wastes, these conditions are sufficient to achieve destruction and removal efficiencies (DRE) of 99.99% and better. U.S. Pat. No. 4,543,190 describes such a SCWO process for the oxidisation of organic materials under supercritical conditions.

Challenges that face the SCWO process include corrosion due to the possibility that metal oxides may form on the reactor walls. This is caused by the co-existence of water and oxygen under extreme conditions. To some extent the oxides provide protection to the reactor walls, yet beyond a point they become destructive, and the wall starts to disintegrate. The other challenge is the precipitation of salts and other inorganics that are insoluble in supercritical water. The deposition of these salts on the reactor wall and system piping may cause plugging. However, salt deposition is subject to the process scale, operating conditions and chemical structure of substrates.

It has been proposed in U.S. Pat. No. 6,056,883 that the inorganic precipitates can be removed by flushing with a suitable solvent; however, this requires the SCWO reaction to be stopped. U.S. Pat. No. 5,358,646 proposes that multiple thermal stages can be used for treatment of waste streams. Removal of solid materials (including any precipitate salts formed prior to the waste treatment) is effected in a catalytic process stage. The removal of solid materials reduces the risk of the expensive catalyst becoming poisoned. WO/2006/052207 describes SCWO systems in which an oxidant containing stream is contacted with a substrate containing stream.

It is desirable to have an improved supercritical substrate oxidation process. The process would seek to offer one or more of improved oxidation efficiency; management of inorganic precipitate scale produced (whether to make this easier to remove, or to avoid disruption to the oxidation process); obviation of the need to apply catalytic processes; the potential to provide a continuous process; and the potential to oxidise one or both of liquid and solid waste streams, if possible with the ability to switch between the two.

The invention is intended to improve at least some aspects of current supercritical substrate oxidation processes, if possible by addressing one or more of the problems described above. The application of SCWO-type processes to the disposal of waste, in particular clinical waste, possibly on a laboratory scale, would also be desirable.

### SUMMARY

Accordingly, in a first aspect of the invention there is provided a reactor for oxidation of substrates, comprising: a first reaction chamber configured to dissolve substrates in a fluid, the first reaction chamber comprising a linking outlet; the linking outlet being connected to a tubular reaction chamber downstream of the first reaction chamber, conditions in the tubular reaction chamber being supercritical for the fluid carrying the dissolved substrates. As such, it will often, but not always be the case that conditions in the first reaction chamber are subcritical for the fluid. Where subcritical conditions are used, this can be advantageous as dissolution under subcritical conditions is gentler and safer than equivalent supercritical systems, allowing pre-treatment of the substrate in a relatively safe (with respect to known supercritical systems), energy efficient manner. One advantage of the reactor of the invention is that the multiple reaction chamber design provides for the removal of precipitated solids from the first reaction chamber, improving the efficiency of the second stage oxidation process in the tubular reaction chamber. In addition, by separating the reaction in this way, the overall progress of the reaction can be monitored more efficiently. Further, liquefaction prior to oxidation has operational advantages in terms of the process safety, regulated heat generation and recovery.

Although generally described in terms of the reactor comprising a single first reaction chamber, and a single tubular reaction chamber; it is to be understood that two or more of each chamber may be used in different operating configurations. For instance, two or more first reaction chambers may feed into a single tubular reaction chamber, or a single first reaction chamber may feed into two or more downstream tubular reaction chambers, as appropriate.

Where there are two or more first reaction chambers, switching from one chamber to another can be achieved using a three-way valve. This isolates one of the first reaction chambers while it is being filled, while the operational chamber “is in-line” (i.e. in fluid communication) with the tubular reaction chamber. This arrangement has the following advantages:

1. It secures the continuity of the process, by switching from one first reaction chamber to another, allowing filling of one or more chambers, whilst the contents of one or more others is being processed.

2. It allows for the removal of insoluble solids, such as ‘needles’ and sharps that should not flow to the tubular reaction chamber.

3. It allows for the removal of insoluble salts which have precipitated out of the fluid-substrate mixture.

Where conditions in the first reaction chamber are subcritical for the fluid, dissolution of solids in the fluid, and mixing of liquid waste with the fluid will be encouraged. Almost all of the substrate will either dissolve or mix with the fluid, and hence be carried through the linking outlet to the tubular reaction chamber; however where the presence of the fluid causes the formation of insoluble salts, or where the substrate is not soluble in the fluid (for instance if the waste is glass sharps), these will be removed from the fluid, prior to transfer of the fluid to the tubular reaction chamber. A wide range of removal methods may be used, however, typically gravity separation will be the method adopted.

As used herein the term “gravity separation” is intended to be given its normal meaning in the art; namely, the separation of solids from a suspension using gravitational processes or, in other words, “settling” of the solid from the liquid under gravity. The use of gravity separation in the invention does not prohibit the additional use of other methods such as filtration, flocculation, coagulation and/or suction, which may increase the rate of separation, but in general gravity separation will be used alone.

The provision of a chamber which allows the gravity separation of the precipitated solids from the mixture of substrate and fluid makes efficient use of natural sedimentation processes, and provides for the rapid removal of any precipitated salts or insoluble solids from the main processing stream within the first reaction chamber, allowing the mixture of substrate and fluid to pass to the tubular reaction chamber in a continuous stream if desired. Previous systems have often been limited to batch processing as a result of a desire to separate precipitated solids from the fluid prior to a second oxidation or other reaction stage.

The provision of an outlet for the precipitated solids ensures that these can be completely removed from the reaction mixture, without the need for destruction, ensuring that these solids do not interfere with subsequent chemical and physical processes. The mixture of substrate and fluid which passes into the tubular reaction chamber is generally substantially homogeneous and substantially free of particulates (i.e. in the range 0-5%, 0-2%, 0-1%, 0-0.5% or 0-0.1% particulate).

In many examples, the fluid comprises water. Often the fluid will be primarily an aqueous medium, although other solvents may also be present. Aqueous media are used for their easy availability, and because many purification processes begin with a waste substrate that is already in aqueous form (for instance in aqueous solution or suspension). It is therefore most efficient to process such substrates using water as a base medium for reaction. Often the first reaction chamber will operate under conditions subcritical for the fluid, in these cases, where the fluid is water, the water will generally be heated, compressed or both. As such, the water may be hot compressed water under the conditions of the first reaction chamber, and supercritical water under the conditions of the tubular reaction chamber.

One intended use of the invention is in the destruction of chemically stable hazardous waste streams. the reactor constructed with the intention of targeting clinical (medical) waste (containing pathogenic, infectious and toxic waste) with possible extension of the application to nuclear waste. As such, it is often the case that substrates are selected from substrates found in clinical waste, nuclear waste, sewage, petrochemical and pharmaceutical wastes and industrial waste; this provides systems with utility in the waste disposal industries. Often the substrates are organic, biological and/or on occasion inorganic. The substrate may be a single compound, or simple mixture of compounds with similar reactivity; or the substrate may be a complex mixture of different substances each with different reactivities and which will be oxidised under different conditions. However, the conditions in the tubular reaction chamber will generally be adequate to oxidise all organic matter in the waste. The inorganic matter will generally be present in insignificant amounts (whether because of precipitation in the first reaction chamber, or insolubility and hence removal in the first reaction chamber).

The substrates may be of one type only, or a mixture of one or more of organic, biological and inorganic wastes. As would be understood, it is possible for a particular waste substance to fall into more than one of these three categories. Where these organic, biological and/or inorganic substrates are waste substrates, they will generally be of the type found in the different types of waste described above.

The substrate may be liquid or solid or a combination thereof. It is an advantage of the invention that the reactor can process solid, liquid or combined waste streams without the need for segregation. Where “liquid” substrates are referred to herein, these include simple liquids or mixtures of liquids, liquids containing solutes, and liquids carrying fine particulate matter in their stream (for instances colloidal systems). The term “solid” is intended to include gels. It will also be understood that solid may contain an amount of liquid and still be substantially “solid”, for instance, a substrate described as a sludge, would be a solid as defined herein, but would contain a measurable (perhaps as much as 30 wt %) liquid. The interface between a liquid which contains particulate matter and a solid is intended to be governed by the amount of solid in the substrate. As used herein, a solid will be a “solid” when it contains less than or equal to 30 wt % liquid, so in the range 0-30 wt % liquid. Similarly, a liquid will contain less than or equal to 70% solid, so in the range 0-70% solid.

The substrate may be extruded, piston fed, pumped or simply placed into the first reaction chamber. Where the substrate is solid, it will often be placed, extruded or piston fed into the first reaction chamber, in some examples a syringe pump may then be used to transfer the substrate to the chamber. Liquids will may be fed into the first reaction chamber using a pump or simply poured in, although both methods may be used alone or in combination for both substrates.

In some examples, a portion of the substrate may bypass the first reaction chamber and be fed directly into the downstream tubular reaction chamber. Where this occurs, it will most often be with liquid substrates, as the presence of solids in the tubular reaction chamber would interfere with the oxidation process. Most often, this would be with liquids containing only very low levels of particulate matter, perhaps 2% or less.

The first reaction chamber may be of cylindrical configuration, with a tapered portion, often at the “bottom” in gravitational terms, so that any precipitated or insoluble solids will separate from the fluid into the tapered portion. Where the first reaction chamber is configured to include a tapered portion, whether or not the first reaction chamber is of generally cylindrical or other (for instance rectangular or bulbous) configuration, the base of the taper may be the position of the outlet for precipitated solids. For the avoidance of doubt, the “outlet for precipitated solids” is also the outlet through which it is envisaged that any solids which are insoluble in the fluid under the conditions used (insoluble solids) be removed from the first reaction chamber.

Often the volume of the first reaction chamber will be in the range 500 ml-5 l, often 1 l-3 l, on some occasions 1.5 l-2 l. As can be seen, an advantage of sizing the chamber to this scale allows for the inclusion of a unit in laboratory environments, such that several units may be present in various sites around a single building, such as a hospital.

Although a variety of configurations may be adopted for the first reaction chamber, the inclusion of a cylindrical portion is generally preferred as cylinders include fewer edges or corners. As edges and corners are more prone to corrosion and to trapping precipitated matter, the selection of a cylindrical configuration provides for a first reaction chamber which is less likely to corrode, to become clogged, or subject to scaling. As both the repair of corrosion, and cleaning of the chamber require a break in processing of the substrate, choosing a cylindrical configuration is advantageous.

In some examples, where the first reaction chamber includes a cylindrical portion, the diameter of the cylindrical portion is in the range of 0.25-0.75 of the vessel height, often the chamber diameter is approximately 0.5 times the vessel height.

The first reaction chamber will often be placed in a specifically designed “work station”, where this can be filled safely and easily by the user. Often the first reaction chamber will be restrained so that it may not topple, this may be through any number of methods known to the person skilled in the art, however, where the first reaction chamber is cylindrical, ring bases will often be used.

The outlet for precipitated solids may include an aperture or valve, to facilitate the regular removal and disposal of precipitated and insoluble solids. As the precipitated solids often include salts which are corrosive, at least under conditions of high temperature and pressure, continuous or regular removal of the solid material from the first reaction chamber can limit corrosion damage inside the chamber. In addition, clogging of the reactor can be reduced, for instance of any pipe work between reaction chambers, or scaling of the chambers themselves.

Where the outlet is a valve, it is often a multi-valve system designed to enable the removal of precipitated solids from the first reaction chamber into a secondary chamber. The pressure can then be lowered in the secondary chamber, and the solids can be released from the reactor. Often the valve configuration will be a two-valve configuration. The use of a two-valve system allows for the removal of the solids without loss of pressure (and hence loss of high pressure reaction conditions), in the first reaction chamber. Thus a continuous reaction process can be provided for.

In addition to the dissolution of the substrate in the fluid, and often the precipitation and removal of solids, it can be the case that the first reaction chamber provides for a first stage oxidation of the substrate. In such a first stage oxidation, often it will be the less complex components of a mixed substrate that are oxidised, although the more complex components of a mixed substrate may also undergo oxidation, whether to a final product or simply as a first stage oxidation in a series of oxidation reactions. Where the substrate is a single substance, or a simple mixture of substances which will be oxidised in substantially the same way, oxidation may occur in a single step. In such cases, it is possible that no oxidant will be added to the first reaction chamber, oxidation being completed solely in the second reaction chamber. In such cases, the purpose of the first reaction chamber would be to facilitate dissolution of solid substrates in the fluid, mixing of the fluid with liquid substrates, often precipitation and often the removal of insoluble solids or precipitated salts. The reactor is generally made from corrosion resistant materials such as titanium. Nickel-chromium alloys such as the Inconel® family of alloys may also be used, as may stainless steel such as SS316. These materials are known to resist corrosion from high pressure and supercritical fluids well. SS316 is a stainless steel that withstands pressures of up to 300 bars (30 mPa) and temperatures in the range 300° C.-350° C. Alternative names for this grade of stainless steel include marine grade stainless steel, and a typical chemical composition would be C 0.08 wt %, Cr 16-18 wt %, Mn 1.25-2 wt %, Mo 2-2.5 wt %, Ni 10-11 wt %, P 0.04 wt %, S 0.03 wt %, Si 0.75 wt %, Fe remainder.

The Inconel® alloys are austenitic nickel-chromium-based superalloys. They generally contain nickel, chromium, iron, manganese, silicon, carbon and sulfur; optionally also with one or more of molybdenum, niobium, cobalt, aluminium, titanium, phosphorus and boron. Specific examples of the Inconel® alloys include:

Element (% by mass)

| Inconel | Ni | Cr | Fe | Mo | Nb | Co | Mn | Cu |
|---|---|---|---|---|---|---|---|---|
| 600 | 72.0 | 14.0-17.0 | 6.0-10.0 | — | — | — | 1.0 | 0.5 |
| 617 | 44.2-56.0 | 20.0-24.0 | 3.0 | 8.0-10.0 | — | 10.0-15.0 | 0.5 | 0.5 |
| 625 | 58.0 | 20.0-23.0 | 5.0 | 8.0-10.0 | 3.15-4.15 | 1.0 | 0.5 | — |
| 718 | 50.0-55.0 | 17.0-21.0 | QS | 2.8-3.3 | 4.75-5.5 | 1.0 | 0.35 | 0.2-0.8 |

| | Element (% by mass) continued | | | | | | | |
|---|---|---|---|---|---|---|---|---|
| Inconel | Al | Ti | Si | C | S | P | B | Al |
| 600 | — | — | 0.5 | 0.15 | 0.015 | — | — | — |
| 617 | 0.8-1.5 | 0.6 | 0.5 | 0.15 | 0.015 | 0.015 | 0.006 | 0.8-1.5 |
| 625 | 0.4 | 0.4 | 0.5 | 0.1 | 0.015 | 0.015 | — | 0.4 |
| 718 | 0.65-1.15 | 0.3 | 0.35 | 0.08 | 0.015 | 0.015 | 0.006 | 0.65-1.15 |

The first reaction chamber may be made of one or more materials, alone or in combination. For instance the first reaction chamber may be steel or a nickel alloy, often stainless steel, such as SS316. The first reaction chamber may be lined or coated on some or all of the internal surface to improve corrosion resistance, often substantially all of the internal surface will be lined, often with a corrosion resistant metal selected from gold, silver, titanium, or alloys of these; chromium, nickel, manganese and combinations thereof. Such alloys optionally include silicon or carbon and may have been processed to improve their corrosion resistance.

Where present, any valve at the outlet for precipitated solids may be made from the materials described above, alone or in combination, often the valve will be formed from titanium, or a titanium alloy. Alternatively, the valve may be coated in titanium. The use of titanium provides corrosion resistance.

The tubular reaction chamber is generally also formed from the materials described above, although as the potentially corrosive precipitated solids have been removed, it will often be the case that the internal surface of the tubular reaction chamber is not coated. Often, the tubular reaction chamber will be formed from a corrosion resistant alloy, for instance titanium or a nickel chromium alloy. Where a nickel alloy is used, this will often be an Inconel alloy such as Inconel 625.

Typical volumes for the tubular reaction chamber range from 0.05 l-0.5 l, often 0.1-0.2 l, often 0.125 l-0.15 l, these are often achieved using narrow tubes of appropriate length, for instance in the range ⅛-1 inch (0.32-2.54 cm), often ¼-½ inch (0.64-1.27). As noted above, an advantage of sizing the chamber to this scale allows for the inclusion of a unit in laboratory environments, such that several units may be present in various sites around a single building, such as a hospital.

As described above, the output from the first reaction chamber after dissolution of the substrate, and removal of any precipitated or insoluble solids, will generally be a liquid. This liquid can then be pumped under into the tubular reaction chamber for further processing. Alternatively, gravity transfer may be used; or the pressure applied in a continuous process from unreacted substrate passing into the first reaction chamber. If the first reaction chamber is operated at conditions which are subcritical for the fluid, it will be at the point of entry into the tubular reaction chamber, via the linking aperture, that the fluid will become supercritical.

A mixing valve may be provided, between the first reaction chamber and the tubular reaction chamber, for instance to allow the mixture of substrate and fluid to be passed from the first reaction chamber to the tubular reaction chamber through more than one conduit, or to allow the products from more than one first reaction chamber to feed into a single tubular reaction chamber. The flow rate is often maintained at a high enough level to secure fully turbulent flow in the tubular reaction vessel.

The tubular reaction chamber is downstream of the first reaction chamber and is intended, generally, for “second stage” treatment in order to secure complete (or near complete) conversion of the substrate. The processes constituting conversion of the substrate will depend upon the nature of the substrate, but they will generally include a combination of precipitation and oxidation. If used in only one “stage” or reaction vessel, oxidation will generally form the “second stage”, and will hence occur in the tubular reaction vessel. As such, oxidation may not occur in the first reaction chamber, which may be used solely for dissolution of the substrate, and optional separation of insoluble components and precipitated salts. Where the substrate is waste, it is generally desirable to destroy the waste by converting it substantially or entirely to benign products such as water, nitrogen, carbon dioxide, chloride ions, nitrates, sulfates, and phosphates.

The configuration of the tubular reaction vessel provides for an improved efficiency of conversion of the waste materials, however, the tubular configuration works most efficiently where precipitates have been removed prior to transfer of the reaction mixture (i.e. the mixture of the substrate and fluid) to the tubular reaction vessel. As such, it will generally be the case that the first reaction chamber will remove most if not all (95%, often 98% or 99% or 99.5% or 99.9%; so in the range 95%-99.9% or 100%, 98%-99.9% or 100%, 99.5%-99.9% or 100%, or 99.9%-100%) of the precipitated solids prior to transfer of the reaction mixture to the tubular reaction chamber.

The tubular reaction chamber is often a plug flow reactor.

Oxidant may be added to the first reaction chamber and/or to the tubular reaction chamber. In many cases, the tubular reaction chamber will be the only chamber where oxidant is used, in such cases the first reaction chamber could be considered to be a pre-treatment chamber in which substrate is dissolved and in which insoluble solids and precipitated (typically inorganic) salts are separated from the mixture of substrate and fluid. Often the oxidant will comprise oxygen, often the oxidant will be selected from hydrogen peroxide, oxygen, oxygen enriched air, and/or air as these oxidants are readily accessible, and their reactions are easy to control.

Often the substrate is oxidised using excess oxidant, the use of excess oxidant ensures that substantially all, of not all (90%, often 95%, often 98%, if not 99%, 99.5% or 99.9%; so in the range 90%-99.9% or 100%, 95% to 99.9% or 100%, 98%-99.9% or 100%, 99.5-99.9% or 100% or 99.9%-100%) of the substrate is oxidised. The use of excess oxidant is desirable where the substrate is a mixture of components with different oxidation behaviour; in such cases the use of excess oxidant can help to ensure that more of the substrate is oxidised. As used herein, the term “excess oxidant” is intended to refer to a stoichiometric excess of oxidant.

Where used, the oxidant can be added to the first reaction chamber through an inlet. Often the oxidant is added to the first reaction chamber and/or to the second reaction chamber through multiple inlets either in the first or second chamber. The use of multiple oxidant inlets (in particular in the tubular reaction chamber) improves the efficiency of substrate conversion, in particular of any nitrogen containing fractions of the substrate. These benefits are observed, in particular, where multiple oxidant inlets are used in the tubular reaction chamber as at each stage of flow of the reaction mixture through the tubular reaction chamber, more oxidant is added, ensuring a good mixing of oxidant with unreacted substrate and hence a greater percentage of substrate oxidation.

If multiple oxidant inlets are used in one chamber only, they will be used in the tubular reaction chamber as this chamber is configured to make the most efficient use of the multiple inlets. It will often be the case that a single, or just two or three, oxidant inlets will be present in the first reaction chamber, if these are present at all.

It has been found that the feed position of the oxidant into the tubular reaction chamber, and the split ratio are among the factors that affect the efficiency of the oxidation process, gradual addition of the oxidant has advantages in terms of enhanced conversion of waste, regulated release of reaction energy, which is safer and more efficient in terms of utilising the released energy, and improved conversion of the nitrogen fraction favours the production of benign N₂ as opposed to the greenhouse gas N₂O. The best conversion efficiency being achieved when in the range 65-85% or 70-80% of the oxidant is fed into the tubular reaction chamber at or near to the entrance of this chamber, and 15-35% or 20-30% oxidant being added approximately halfway along the length of the tubular reaction chamber. The best results have been observed when approximately 75% (optionally ±2%) of the oxidant is fed at the entrance, and approximately 25% (optionally ±2%) half way along the length of the tubular reaction chamber. As used herein, the term “halfway” is intended to mean in the range 40-60% of the distance along the longitudinal axis (the “length”) of the tubular reaction chamber, often in the range 45-55%, or 50±2% of the distance along the longitudinal axis of the tubular reaction chamber.

Another advantage of multiple-oxidant feed is that this regulates the heat distribution (and therefore the temperature) along the length of the tubular reaction chamber. As oxidation generates rapid and massive heat; regulating the reaction extent will also regulate heat generation and minimise heat losses and wastage.

Prior to addition to the first and/or tubular reaction chamber the oxidant may be compressed to a pressure at least equal to and preferably above the pressure in the chamber to which it is being added. Any known compressor, such as an air pump, may be used. Oxidant pressure often greater than or equal to 220 bars (22 mPa) and may be in the range 240-260 bars (24-26 mPa), often at approximately 250 bars (25 mPa).

In a second aspect of the invention there is provided a process for the oxidation of substrates comprising: dissolving a substrate in a fluid in a first reaction chamber; passing a mixture of substrate and fluid into a downstream tubular reaction chamber; oxidising the substrate under supercritical conditions; and discharging the products of the oxidation from the reactor. The process may comprise either or both of the additional steps of allowing precipitated and insoluble solids to separate by gravity from the mixture of substrate and fluid; and the step of removing the precipitated and/or insoluble solids from the first reaction chamber.

Generally both the tubular reaction chamber will operate under supercritical conditions for substantially all, if not all, of the process. This is of use as high levels of energy are needed to return a supercritical fluid to a supercritical state once it has reverted to the ambient state for that substrate. It is therefore more efficient to maintain the supercritical fluid in a supercritical state throughout the reaction process.

It is an advantage of the inventive process that substrates can be oxidised in high yield without the need to use catalysts. This reduces the cost of the process and simplifies the reactions occurring as the only additional reaction component becomes the oxidant. As such, it may be that the process of the invention, and the reactor, do not include catalysts as catalysts are not required for use in this invention. However, they are not explicitly excluded, and may be used if the reaction under consideration would be aided by the presence of a catalyst, and the presence of the catalyst either does not introduce operating problems, or any operating problems introduced are outweighed by the benefits of catalyst use.

Often the process of the invention will be continuous, although batch oxidation may also be used. The advantage of any continuous process is the removal of the need to stop processing and reset the reactor, a particular advantage of adopting continuous processing in the inventive process is that often the substrates to be oxidised will form part of a continuously produced stream, such as a waste stream, and inserting a continuous method of processing the waste into the stream is more efficient than creating storage vessels for the stream to allow batch processing.

In order to ensure optimal reaction conditions, the first reaction vessel will generally be maintained at a temperature in the range 250° C.-350° C., often in the range 275° C.-325° C., often around or just below 300° C., for instance 290° C.-295° C. The first reaction vessel will often also be pressurised, pressures will typically be at a value in the range 240-260 bars (24-26 mPa), often 240-250 bars (24-25 mPa). Adopting this combination of temperature and pressure provides for a system in which the fluid has excellent solvation properties, but which is not supercritical, reducing the risk associated with using the apparatus.

In order to ensure supercritical conditions, the tubular reaction vessel is generally maintained at a temperature in the range 400° C.-500° C., often in the range 400° C.-550° C., sometimes 400° C.-500° C. in the tubular reaction vessel. The skilled person will understand that the temperature of the tubular reaction vessel is selected to ensure supercritical conditions, yet balance the additional cost associated with increasing the temperature at which processing is carried out. Where water forms the reaction medium/fluid, the tubular reaction chamber must be maintained at a temperature in excess of 374° C., if supercritical conditions are to be achieved. In addition, maintaining a temperature equal to or greater than 400° C. reduces the corrosiveness of the supercritical fluid as corrosion is less likely to occur at temperatures outside the range of 270° C.-390° C., thus controlling the temperature can also control corrosion.

Pressures in the tubular reaction chamber will typically be at a value independently in the range 240-260 bars (24-26 mPa), often around 250 bars (25 mPa) to ensure supercritical conditions are maintained.

As the process takes place under high pressure and high temperature (often supercritical) conditions safety is important so a system of relief valves and automatic back pressure regulators will often be used, often a bursting disk will be fitted to the first reaction chamber.

In a third aspect of the invention, there is provided the use of the reactor of the first aspect of the invention for the oxidation of substrates. In use waste is generally added directly to the reactor, via the first reaction chamber. Once full, the first reaction chamber can be sealed, heated and pressurised to the desired temperatures and pressure (often around 300° C. and 250 bar/25 mPa). The first reaction chamber is also connected to the tubular reaction chamber. Connection is generally through simple sealing of the first reaction chamber and opening of the linking aperture. Heating is often achieved through the use of a jacket heater, although a range of techniques may be used as appropriate for the size of the vessels and the environment in which they are placed. Pressurisation can be achieved through pumping of fluid into the first reaction chamber, a range of different pumps may be used, however, often a HPLC pump will be selected.

As noted above, there will generally be at least two of the first reaction chamber, facilitating the filling of one or more of these, whilst the waste contained in one or more of the reaction chambers is being processed. Where multiple first reaction chambers and/or tubular reaction chambers are present, the linking outlet may be a multi-way valve, although simple “on/off” valves may also form the linking outlet, which then allows flow to a multi-way valve. Such a configuration provides an additional level of system control and hence safety.

Once these conditions of temperature and pressure are achieved, the first reaction chamber becomes operational and dissolution/mixing begins. The mixture of the fluid and substrate can then pass into the tubular reaction chamber, via the linking outlet. Generally, no pumping is required, as the pressure in the first reaction chamber is sufficient to provide for natural egress of the mixture of the fluid and substrate from the first reaction chamber to the tubular reaction chamber when the linking outlet is open. Typically, the flow rate will be such that the fluid entering the tubular reaction chamber has a turbulent flow, aiding oxidation of the substrate.

The reactor of the invention has been found to give destruction of a diverse range of substrates, including organic waste materials, toxic materials, and infectious materials such as medical waste, with 99.9% efficiency.

The inert output from the tubular reaction vessel may be at elevated pressure and temperature, often as high as 250 bars (25 mPa) and approximately 500° C. As such, it contains high grade heat; this can be recovered through a heat exchanger unit through which may also be pumped, any liquid substrate stream to pre-heat the liquid substrate prior to entry into the first, or tubular, reaction chamber. This reuse of heat further increases the efficiency of the inventive process. Alternatively, the heat may be diverted to other applications, if desired.

The inert output, whether or not passed through a heat exchanger unit (although this will typically be the case), can then be passed into a separator unit to separate liquids from gases. The liquid may consist mainly of water sometimes containing a low concentration of inorganic salts, while the gas stream may contain benign gases such as nitrogen and carbon dioxide.

Unless otherwise stated each of the integers described in the invention may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

### BRIEF DESCRIPTION OF THE DRAWINGS

In order that the present invention may be more readily understood, it will be described further with reference to the figure and to the specific example hereinafter.

FIG. 1 is a schematic illustration showing a supercritical water oxidation apparatus in accordance with the invention, the system having a single first reaction chamber and a single tubular reaction chamber; and

FIG. 2 is a further schematic illustration showing a supercritical water oxidation apparatus in accordance with the invention, the system having two first reaction chambers and a single tubular reaction chamber.

### DETAILED DESCRIPTION

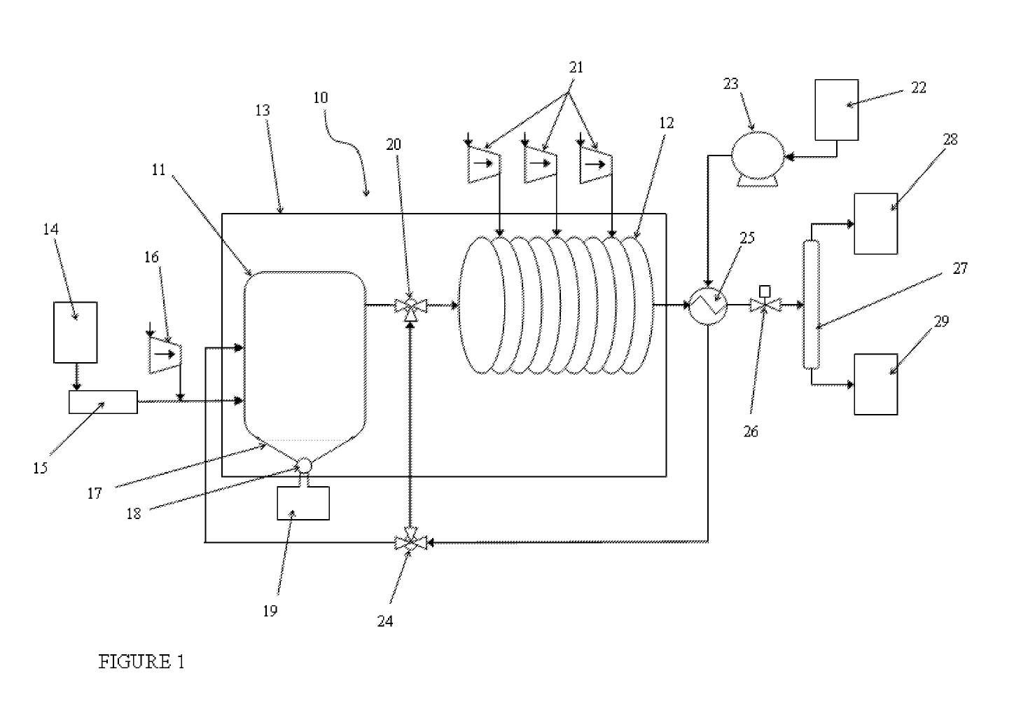

The reactor 10 of FIG. 1 comprises a first reaction chamber 11 and a tubular reaction chamber 12 contained within a heater 13. The heater 13 can be an oven or other suitable means for heating to temperatures near to and above the supercritical temperature of water. In this example a detachable jacket heater is used. The vessel 11 is of volume 2 litres and is made from the nickel alloy Inconel645 and lined with titanium.

Waste material comprising mainly solid waste in storage container 14 is passed to high pressure extrusion unit 15 which forces the waste under pressure through a pipeline into the first reaction chamber 11. Oxidant in the form of oxygen gas is introduced into the first reaction chamber 11 by compressor 16 at a pressure of 250 bar (25 mPa).

The reaction to precipitate solid salts from the waste in the first reaction chamber 11 takes place at a temperature between 250° C. and 350° C. at a pressure of 250 bar (25 mPa).

A tapered portion 17 of the first reaction chamber 11 has a conical profile and tapers to valve 18. Valve 18 is a titanium valve through which any precipitated salts can be removed into secondary chamber 19 without affecting the pressure in the first reaction chamber 11. When valve 18 is closed the secondary chamber 19 can be returned to atmospheric pressure and removed from the system, any insoluble solids and precipitated salts being collected and either reused or discarded.

The part-processed waste from the first reaction chamber 11 is passed through a mixing valve 20 (the linking outlet) to a tubular reaction chamber 12. The tubular reaction chamber 12 has a tubular configuration and is made from the nickel alloy Inconel625. The tubular reaction chamber has a ¼ inch diameter (0.63 cm) and is of volume 0.125 litre. The temperature and pressure in the tubular reaction chamber 12 is maintained at a temperature between 450° C. and 500° C. at a pressure of 250 bar (mPa).

The tubular reaction chamber 12 features two oxidant inlets supplied from compressors 21 through which oxygen gas or oxygen enriched air is provided at a pressure of 250 bar (25 mPa). 75% of the oxidant enters the tubular reaction chamber 12 through an oxidant inlet near to the entrance of the tubular reaction chamber 12, and 25% through an oxidant inlet roughly half way along the length of the tubular reaction chamber 12.

Liquid waste stored in container 22 is fed into the system through liquid pump 23 at an outlet pressure of 250 bar (25 mPa). After going through the liquid pump 23 the liquid waste passes through a 3-way valve 24 from which it can be directed to the first reaction chamber 11 or direct to the mixing valve 20 and into the tubular reaction chamber 12.

The inert output from the tubular reaction chamber 12 is passed through a heat exchanger unit 25 to transfer heat to the incoming liquid waste so it is preheated before entering the first or tubular reaction chamber to make the process more energy efficient.

After exiting the heat exchanger 25 the inert output material is passed through backpressure regulation valve 26 and into the gas/liquid separation unit 27 from which the gas phase is collected in storage unit 28 and the liquid phase is collected in storage unit 29.

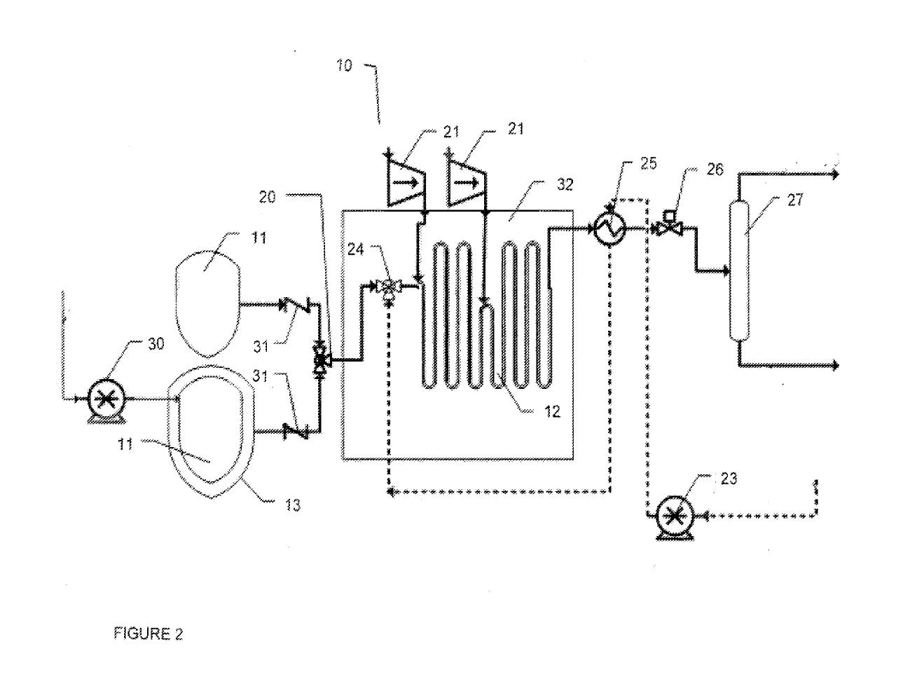

FIG. 2 shows a reactor of the invention but with two first reaction chambers 11 each made of stainless steel (SS316) and operated at a pressure of 260 bar (26 mPa) and temperature around 300° C. In this configuration one chamber 11 can be processed whilst the second is being filled and vice versa, providing for a continuous processing system. In this embodiment the volume of the first reaction chamber is 1 litre, and filling is via simple addition of substrates to the open first reaction chamber 11.

The presence of two first reaction chambers 11 requires the presence of a three-way mixing valve, allowing flow from one or other of these chambers to the tubular reaction chamber.

The first reaction chamber is enclosed in a detachable jacket heater 13 and is connected to pump 30, where water is pumped at 250 bars (25 mPa), for pressurisation.

A waste exit stream passes through a safety on-off valve 3, onto a mixing valve 20, onto the heating chamber 32. Three-way valve 24 can be used to allow the addition of other preheated liquid wastes, with mixing, prior to passing into the tubular reaction chamber 12.

Oxidant in the form of oxygen gas is introduced into the tubular reaction chamber 12. It has a tubular configuration with plug flow design, made of Nickel alloy Inconel625. Heating of the tubular reaction chamber is achieved using an oven 13.

The tubular reaction chamber 12 features double oxidant inlets supplied by compressors 21 through which, oxygen gas or oxygen enriched air is provided at a pressure of 250 bar (25 mPa).

Inert output from the tubular reaction chamber 12 is passed through a heat exchanger unit 25 where its high-grade heat content is recovered by heating the incoming liquid waste, entering the tubular reaction chamber 12, making the process more energy efficient.

After exiting the heat exchanger 25 the inert output material is passed through automated backpressure regulator (BPR) 26. BPR 26 is responsible for keeping the whole system under constant pressure, regardless of the change in the waste properties and flow.

The expanded exit material is at atmospheric pressure and room temperature. It is fed into the gas/liquid separation unit 27 from which the gas phase is vented to atmosphere; the liquid phase is discarded.

It should be appreciated that the reactors, processes and uses of the invention are capable of being incorporated in the form of a variety of embodiments, only a few of which have been illustrated and described above.

1. A reactor for oxidation of substrates, comprising: a first reaction chamber configured to dissolve substrates in a fluid, the first reaction chamber comprising a linking outlet; the linking outlet being connected to a tubular reaction chamber downstream of the first reaction chamber, conditions in the first reaction chamber being subcritical for the fluid, and conditions in the tubular reaction chamber being supercritical for the fluid carrying the dissolved substrates.

2. The reactor according to claim 1, wherein the fluid comprises water.

3. The reactor according to claim 2, wherein the fluid in the first reaction chamber is hot compressed water, and/or wherein the fluid in the tubular reaction chamber is supercritical water.

4. The reactor according to claim 1, wherein the substrates are selected from substrates found in clinical waste, nuclear waste, sewage, and industrial waste.

5. The reactor according to preceding claim 1, wherein the substrates are organic, biological and/or inorganic.

6. The reactor according to claim 1, wherein the first reaction chamber is additionally configured to separate solids precipitated from the fluid and/or insoluble solids, by gravity separation to an outlet for precipitated solids.

7. The reactor according to claim 1, wherein the first reaction chamber is a cylindrical vessel.

8. The reactor according to claim 1, wherein the tubular reaction chamber is a plug flow reactor.

9. The reactor according to claim 1, wherein oxidant is added to the first reaction chamber and/or to the tubular reaction chamber.

10. The reactor according to claim 9, wherein the oxidant comprises oxygen.

11. The reactor according to claim 9, wherein oxidant is added to the first reaction chamber and/or to the second reaction chamber through multiple inlets.

12. A process for the oxidation of substrates comprising:
dissolving a substrate in a fluid under subcritical conditions in a first reaction chamber; passing a mixture of substrate and fluid into a downstream tubular reaction chamber; oxidising the substrate under supercritical conditions; and
discharging the products of the oxidation from the reactor.

13. The process according to claim 12, comprising the additional steps of:
allowing precipitated and insoluble solids to separate by gravity from the mixture of substrate and fluid; and
removing the precipitated and/or insoluble solids from the first reaction chamber.

14. The process according to claim 12, which is continuous.

15. The process according to claim 12, wherein the first reaction vessel is maintained at a temperature in the range 250-325° C. and/or the tubular reaction vessel are maintained at a temperature in the range 400-600° C.

16. The process according to claim 12, wherein the substrate is oxidised using excess oxidant.

17. The process according to claim 12, wherein the substrate is oxidised in the first and/or the tubular reaction chamber.

18. The process according to claim 17, wherein the substrate is oxidized in the tubular reaction chamber only.

19. The process according to claim 18, wherein the substrate includes a combination of solid and liquid substrates, and wherein the liquid substrate is oxidized in the tubular reaction chamber only.

20-21. (canceled)
